(19) United States
(12) Patent Application Publication
(10) Pub. No.: US 2005/0242570 A1
(43) Pub. Date: Nov. 3, 2005

(54) Collection maintenance and introduction form and method of using same

(76) Inventors: Joseph John Gecha, Nevada, MO (US); Michael C. Maier, Carthage, MO (US)

Correspondence Address: WARD KRAFT, INC., P.O. BOX 938, FORT SCOTT, KS, 66701, US

(21) Appl. No.: 10/838,015

(22) Filed: May 3, 2004

(51) Int. Cl. B42D 15/00

(52) U.S. Cl. 283/98

(57) ABSTRACT

The business form assembly of the present invention is a pressure sensitive laminated construction that is used in connection with the introduction of pieces and maintenance of collections and records for libraries, museums and other institutions having repositories of resource materials, artifacts and other pieces for exhibit or use. The assembly has a plurality of removable elements that include a card pocket, recordation card, pressure sensitive labels as well as other separable elements including bookmarks, card catalogs and other labels. The form is generally planar and may be processed through a non-impact printer such as a laser printer or ink jet printer.

### CROSS-REFERENCES TO RELATED APPLICATIONS

None.

### FIELD OF THE INVENTION

The present invention is found in the field of business forms and documents that are suitable for use in creating, introducing and maintaining collections such as books, references, periodicals, antiquities, art and the like. More specifically, the business form of the present invention is a laminated, non-impact printable, pattern coated pressure sensitive construction that contains a plurality of removable and useable elements suitable for documenting and cataloging various resources contained or held in public, private or professional organizations. The business form construction of the present invention with its selectively detachable components, having matching or commonality of information may be used in a variety of ways in order to achieve a particular purpose such as the introduction of a new component or piece into the collection being maintained by the institution.

### BACKGROUND OF THE INVENTION

The collection, introduction and maintenance of materials and resources for professional, private and public collections, such as libraries, museums, repositories and the like has heretofore been accomplished through the use of various individual components, such as pockets, cards, tags, labels and the like. The curator, librarian, custodian or other staff personnel must individually print, such as by hand, catalog cards, card pockets, labels, inserts and other documents that are needed to retain the relevant information. Such a process is often time consuming and leads to disparities in the recordation of information used on the materials contained within the collection as different individuals at different times are responsible for the capture of information, which is often done manually. Such idiosyncrasies lead to inconsistencies within the collection and may cause portions of the collections to be misplaced, misfiled or have other unintended consequences.

Efforts have however been made to add efficiencies to the building and maintenance of such collections. These have included card pocket combinations such as that illustrated in U.S. Pat. No. 5,318,324. While this construction provides certain advantages, it unfortunately required the purchase of expensive post imaging equipment such as business forms sealers, or pressure sealers, in order to complete the construction prior to being used.

Another example of prior solutions was the creation of sheets of multiple card pockets or cards each in a single form construction. While such a construction generally permitted the production of card pockets or a plurality of cards, the form assembly still required the resource technician or custodian to manually associate these components for the piece, leading to possible mismatches or errors, as well as acquire and use labels, card catalog documents, bookmarks and other items that may be necessary to capture relevant information for the collection. In addition, such constructions are generally intended for the production of four or more card pockets at a time. Typically, however, especially with small collections, the librarian or curator may only have the propensity, need or preference to prepare only one piece for the collection at a time and to ensure that each piece is adequately documented and entered before moving to the next task or piece to be added to the collection. Thus, with such prior solutions, the user would then re-feed the previous forms and may inadvertently print information in an area where the card or pocket had been previously removed, requiring restarting of the process.

What is needed therefore is a business form construction that does not require the addition of post imaging equipment and which enables the curator, technician or librarian to effectively and easily, fully complete the entry of each piece into the collection that they are responsible for.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention provides a complete business form assembly that is suitable for use by museum curators, reference and resource technicians, collection custodians, librarians and volunteers serving public, private and professional institutions. The form assembly provides a single use application that enables the efficient recordation of information pertinent to the piece.

In one embodiment of the present invention, a business form assembly for maintaining collections is provided and includes a first or lower substrate having first and second faces with the first face being coated with a pattern of pressure sensitive adhesive to provide a securing means for holding the form construction together. The pattern includes at least one substantially quadrate pattern internally of an outer edge of the substrate. A second or upper substrate is included in the present form construction which is substantially coextensive with the first substrate and has first and second faces. The second face of the substrate is in contact with the first face of the first substrate. A card pocket is formed in the second substrate by a first die cut defining an outer perimeter of the card pocket. The card pocket has a die cut internally of the outer perimeter that defines an opening in the pocket to allow receipt of a recordation card. The recordation card included in this embodiment is formed in the second substrate by a second die cut that defines an outer perimeter of the recordation card; the outer perimeter of the recordation card is less than the outer perimeter of the card pocket, so that the recordation card will fit within the internal die cut of the card pocket.

Also included with the presently described embodiment is the availability of at least one removable label that is formed in the second substrate by a third die cut that defines an outer perimeter of the removable label. The outer perimeter of the removable label is less than the outer perimeter of each of the card pocket and the recordation card. The present construction is also provided with at least one additional removable element that is formed in the second substrate by a fourth die cut that defines an outer perimeter of the removable element. The area created by this die cut is at least equal to the area created by the perimeter of the label. At least a portion of the card pocket and the removable label have a pressure sensitive adhesive coating thereon after being removed from the laminated assembly.

The business form assembly of the foregoing embodiment also includes a release coating that is applied on the first face of the first substrate so that the adhesive may release or transfer to selected portions of the assembly, when such portions are removed from the assembly.

The form assembly may also include a catalog card, additional label or labels and bookmark, each of which are removable from the assembly and are created through the use of die cuts that define the respective perimeters of each of the elements. The form assembly of the foregoing embodiment may also include a radio frequency identification tag (“RFID”) or label.

In a further exemplary embodiment of the present invention, a method of using a form assembly for maintaining a collection, is described and includes the steps of initially obtaining a piece for installation in a collection. The piece may be a book, periodical, reference, art, artifact, antiquity or such other item that may be desirable for accumulation and collection.

Data relating to the piece is input into a computer. The computer may be at the same location as the collection or may be at a remote site. A collection recordation form is then provided and processed through a non-impact printer such as a laser printer, ink jet or ion deposition print engine. The collection recordation form includes at least a card pocket, recordation card and a removable label.

Next, at least the card pocket, recordation card and removable label are imaged using the data that was input into the computer. Once the imaging has been completed, the card pocket, recordation card and removable label are then removed from the recordation form and each are affixed to predetermined areas of the piece. Finally, the piece is installed into the collection where it may be extracted by users of the facility.

The exemplary method described above may include other steps and processes, such as the collection form may include additional labels, a catalog card and bookmark which would be substantially simultaneously imaged along with the card pocket, recordation card and label. These additional pieces would then be removed and inserted or utilized in the appropriate area. For example, the catalog card would likely be placed into the card catalog where a researcher might discover the card in connection with a search for material. The bookmark may be inserted into the book. In addition, the bookmark could be imaged with advertising or marketing collateral, such as by the sponsor of the institution or promotional offers such as coupons, discounts and the like. The imaging that is provided on the separable elements is generally matching indicia or at least will have some common elements displayed on each of the separable elements so as to facilitate identification of the pieces.

In a still further embodiment of the present invention business form intermediate for use in recording pieces for a collection is described and includes a laminate that has at least a first and second sheet, with each of the sheets having a first face and a second face. The sheets of the laminate are joined to one another through use of a pressure sensitive adhesive.

In the still presently described embodiment, a series of die cuts are provided in the first sheet of the laminate to create a number of separable and detachable elements that include at least a card pocket, recordation card, label and at least one other removable element, with each of the die cuts defining an outer perimeter of each of the card pocket, recordation card, label and removable element.

The card pocket of this embodiment has a cut out that creates an opening into which the recordation card will fit once the card and the card pocket are removed from the laminate. The card pocket has an area that is defined by the perimeter which is greater than an area of the recordation card that is defined by the perimeter of recordation card created by the respective die cut.

The label that is provided in the exemplary form intermediate has an area that is defined by the perimeter of the die cut for the label with the area being less than each of the areas of the card pocket and the recordation card. The at least one other removable element that is included in this form construction has an area that is defined by the perimeter of the die cut for the at least one other removable element, and the area is at least equal to that of the area of the label.

The business form intermediate is generally substantially planar so that it may be processed through a non-impact printer such as a laser printer or ink jet printer. The indicia that is provided will typically be matching or at least have some common elements that are related to one another on each of the separable components to facilitate identification and record keeping.

The removable element included with this form construction is selected from a group including a bookmark, a catalog card and pressure sensitive label. In addition, the form construction of the present embodiment may also include a radio frequency identification tag (“RFID”) or other sensor component which would aid in theft reduction of pieces contained within the collection.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the business form assembly of the present invention;

FIG. 2 provides a front view of the lower or base substrate and the upper face of that base substrate and illustrating an exemplary pattern of adhesive coated on the first face;

FIG. 3 illustrates a cut away side view of the laminated construction taken along line 2 of FIG. 2 showing the adhesive pattern used to hold the laminated construction of the present invention;

FIG. 4 presents an exemplary piece found in a collection and showing the card pocket, card and book mark obtained from use of the laminated construction of the present invention;

FIG. 5 shows an exemplary piece found in a collection and showing one of the removable labels used in identification of the piece; and

FIG. 6 provides a block diagram of an exemplary method of using the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, it has been discovered that an all inclusive information handling assembly is currently not available for use in libraries, museums and other repositories where collections or pieces intended to be used in study, research or display are regularly or routinely found.

The business form assembly of the present invention provides a simple and efficient construction through which one may easily record pertinent information and then remove each of the separable elements for identification and tracking of the piece that is to be installed in the collection. The business form is provided in a generally planar arrangement and can be easily processed through a non-impact printer and does not require additional sealing or processing equipment in order to be utilized in cataloging the work or piece. In addition, the business form assembly of the present invention can have any number of the separable or detachable elements imaged or printed with matching indicia to aid in the cataloging and identification of pieces that are held in the collection.

The business form assembly of the present invention can be used for books, periodicals, audio visual materials, works, such as artistic materials, reference materials, art, artifacts, antiquities, pieces, components and other items that are commonly found in museums, libraries and other repositories whether public, private of professional. The form has been designed so as to provide a complete and easy to use solution for the user and provides the resource or reference technician, librarian, custodian or other individual with a complete set or substantially complete set of components that can be used in identifying, tracking and recording information related to the piece that is to be installed in the collection.

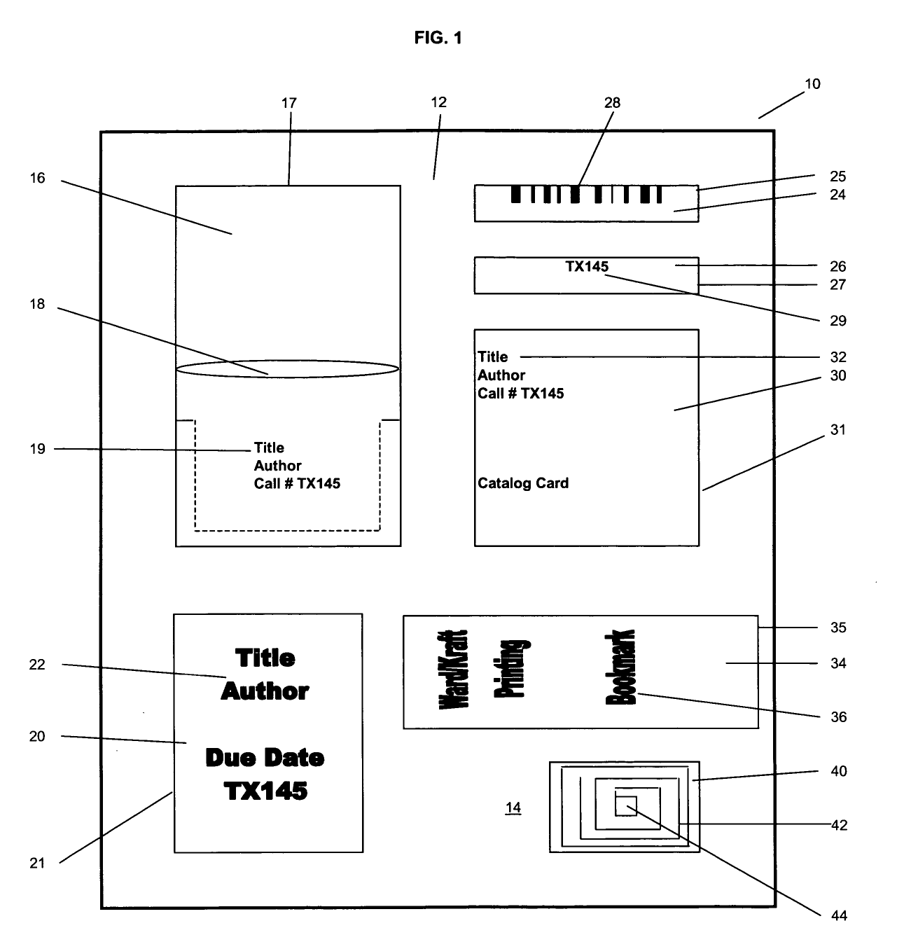

FIG. 1 of the present invention is used to depict a front illustration of the top of the form construction or form intermediate and is generally depicted by reference to numeral 10. The assembly 10, as shown in FIG. 1, provides a top sheet 12 having a front or first face 14. It should be understood that while only the front or rear face or surface may be shown in the drawings it should be readily understood that the substrates or sheets used in the construction of this assembly will naturally have front and back faces or first and second surfaces or a top side and a bottom side.

The top sheet 12 is generally and preferably selected from a cellulosic material ranging from 20 pound bond paper to 100 pound tag stock with 80 pound card stock being generally preferred. However, it should be understood that stock selection is dependent upon the use to be made of the form assembly. Generally, however, the top sheet 12 of the form assembly should be sufficient to enable die cutting and provide separable elements (to be discussed) that can adequately perform the function to which they are to be used. In addition, where the collection dictates the use of certain materials, such as the use of acid free papers in connection with storing and identifying rare works, manuscripts and the like, those materials would be selected for use with the present invention.

Each of the die cuts used herein to form the assembly of the present invention may be die cuts in which the die either completely severs the material around the separable or detachable element or the die cut may include a series of cuts and ties. In the former, where the separable element is disposed over at least a portion of a pressure sensitive adhesive, as will be described herein, the adhesive will removably hold the element in position within the form. In those situations where there is no adhesive beneath the removable element, such as with the recordation card, the card is held in position through the use of ties that are easily broken upon detaching the card from the assembly.

FIG. 1 shows a card pocket 16 which has a perimeter defined by a die cut 17. The die cut 17 as with all other die cuts in this exemplary embodiment extend only through the upper most sheet 12 and not through the second sheet of the assembly. The card pocket 16 is provided with an opening 18 which is created through die cutting to create an opening that is sufficiently large enough to allow a recordation card 20 to be inserted into the opening after the card pocket 16 and recordation card 20 have been removed from the assembly 10. The card pocket 16 is also provided with indicia 19 that is relevant to the article or piece that is to be retained or installed in the collection of the particular repository.

Still referring to FIG. 1, the recordation card 20 is defined by a perimeter 21 that is again created by die cutting. As can be seen from the FIGURE, the recordation card 20 is provided with relevant indicia 22 for the article or piece to be included or installed in the collection. From the illustration, in this example, indicia 22 relate to a library book and may include title of the book, author, “call number” and other relevant information such as due date or the date the book should be returned to the library. As can be seen from the FIGURE, the area created by the perimeter 21 of the recordation card 20 is less than the area created by the perimeter 17 of the card pocket 16. The width of the recordation card 20 is generally less than the width of the opening 18 created in the card pocket 16 so that the recordation card 20 may be easily inserted and removed from the opening 18 such as when a library book is checked out of the institution.

The business form or form intermediate 10 is also provided with at least one removable label 24 and in the present illustration a second removable label 26 has also been provided. The first label 24 is defined by a perimeter 25 which is created by a die cut. The perimeter of the label 24 is generally less than each of the card pocket 16 and recordation card 20 as can be seen from the depiction that has been provided in FIG. 1.

The second label 26 that is provided in the exemplary construction depicted in FIG. 1 is shown generally sized and configured the same as the first label 24, but it should be understood that the second label 26, if provided may be any size depending on the application for which it is to be used. The second label 26 is defined by a perimeter 27 that is again formed by die cutting the first substrate or first sheet 12. The die cuts used for the labels 24 and 26 are cut completely through, that is there are no ties holding the labels in position and rather the pattern of adhesive to be discussed herein serves to hold the labels in position on the form assembly. The second label 26 is shown with an area defined by a perimeter that it at least equal to the area defined by the perimeter of the first label 24.

Label 24 as depicted in FIG. 1 is provided with machine readable indicia 28, which is shown as a bar code. Label 26 is provided with alpha and numeric indicia represented by numeral 29. It should however be understood that a label may contain both machine readable and human readable indicia (alpha and numeric characters) or only one or the other.

FIG. 1 also depicts a form assembly having a removable catalog card 30. The perimeter 31 of catalog card 30 is defined by a die cut, such a die cut would likely be a series of cuts and ties to hold the card 30 in position on the form assembly until it is removed. The catalog card 30 is provided with indicia 32 which is or will likely match the indicia that is provided on the recordation card 20 and some or all of the information on the labels 24 and 26. Likewise, the indicia provided on the catalog card 30 will also carry some level of matching indicia to that provided on the card pocket 16. That is, the indicia 19, 22, 28, 29 and 32 on the pocket card 16, recordation card 20, labels 24 and 26 and catalog card 30 will have some level of commonality of indicia so that the components can easily be matched to one another and aid in the installation of the piece in the collection.

Still referring to FIG. 1, the form assembly 10 is provided with a further separable element 34 which is a bookmark. The bookmark 34 is defined by a perimeter 35 created through the use of a die cut. The bookmark 34 is also printed with indicia 36 which may include some matching information to that printed on some of the other separable elements or the indicia 36 may be printed with marketing or advertising indicia such as that which may relate to a sponsor of an institution or other contributor to a program or an entity that may simply purchase advertising space on the form assembly 10 of the present invention such as in connection with a promotional offer, coupon, discount or the like.

The form assembly 10 shown in FIG. 1 also includes a radio frequency identification tag (“RFID”) 40 which includes a coil winding 42 that may be attached to a silicone wafer or the like 44. Any sensor or antitheft device may however be included in connection with the form assembly and depending on the device, may require activation prior to attachment to the collection piece.

It should be understood that FIG. 1 provides a number of separable elements which may or may not be present in any particular form construction provided to an end user institution. The user or customer may select those items for inclusion during the manufacture of the form assembly. Alternatively, the user may simply not use all of the elements provided on the form construction if they are not needed for the particular application that the form has been selected.

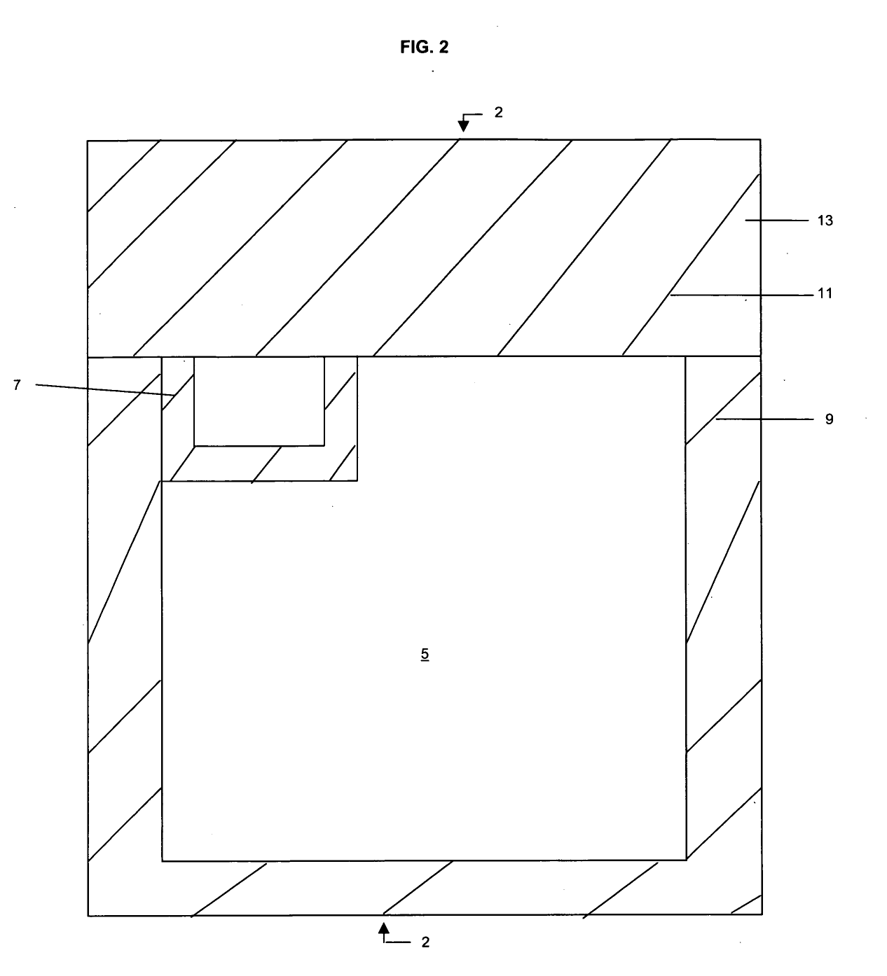

Attention is now directed to FIG. 2 which provides the second sheet or substrate 13 which forms the base of the laminate of the assembly 10. The second sheet or base sheet 13 is provided with a pattern of pressure sensitive adhesive 11, 9 and 7. Pattern 9 will generally extend around the perimeter of the form base sheet and will serve to hold the first and second parts one to another. Pattern 13, which is a substantially quadrate pattern, is disposed internally of the outer perimeter of the sheet and is used beneath the card pocket and removable labels so as to enable the adhesive to transfer to the back or second face of each of the card pocket 16 and labels 24 and 26. The third pattern 7 is provided in a U shape and creates a pattern that will serve to support the lower portion of the card pocket 16 to the book or other article to which the card pocket 16 is attached.

The pressure sensitive adhesive patterns are applied on the first face 5 of the base sheet 13. The adhesive is applied over the top of a release coating, such as silicone, wax or other suitable material which will allow the adhesive to transfer to the back of the desired parts or separable elements as is readily understood by one of skill in the art. The base sheet like the first or uppermost sheet both have front an back faces although in the depiction provided only on face of the respective sheets has been shown.

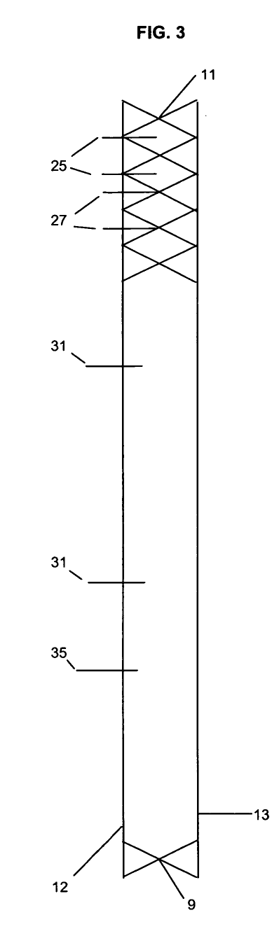

Reference is now directed to FIG. 3 of the present invention which shows the first or upper sheet 12 adhesively connected to lower or base sheet 13 through patterns of adhesive 9 and 11. The FIGURE is taken along line 2 in FIG. 2. The upper sheet 12 is shown with various die cuts that form perimeters 25, 31 and 35 as described in connection with FIG. 1.

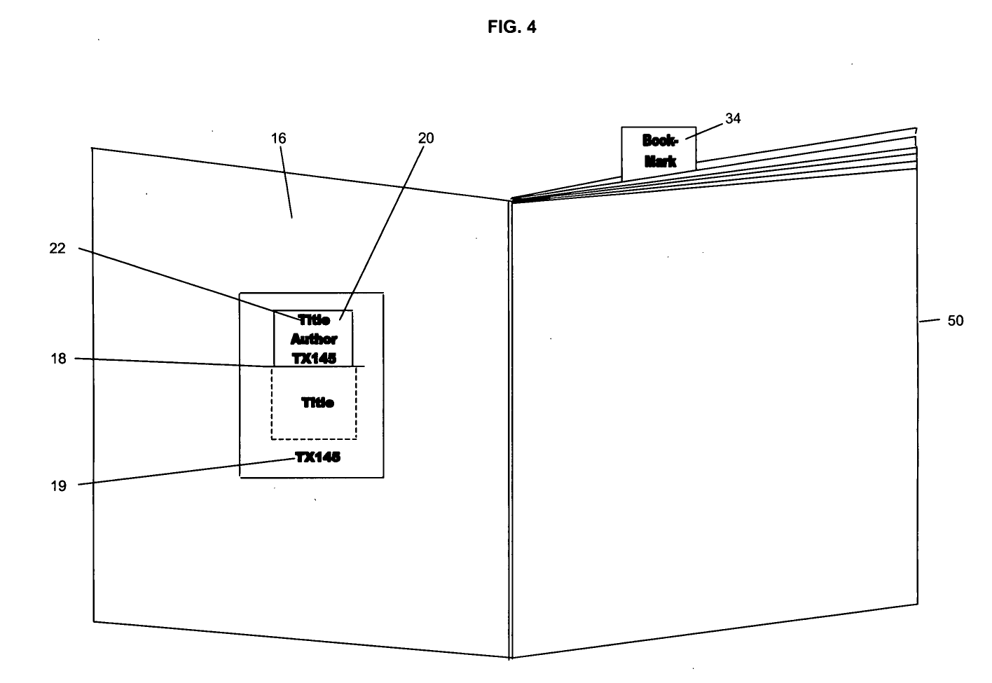

Referring now to FIG. 4, the form assembly has now been processed and various elements detached and used in connection with a piece that is to be installed in a collection. The piece 50 that is depicted is a library book and is used for convenience throughout this description. However, it should be understood that the piece may be any sort of article that would be included in a collection or assemblage.

The card pocket 16 has been removed from the form (not shown) and affixed to the interior of the book 50 through the use of the adhesive patterns that are depicted in FIG. 2. The recordation card 20 has been inserted into the card pocket 16 through opening 18. Indicia 19 and 22 have been provided on the card pocket 16 and recordation card 20 as previously discussed. Desirably, the indicia contain at least some matching or elements of commonality.

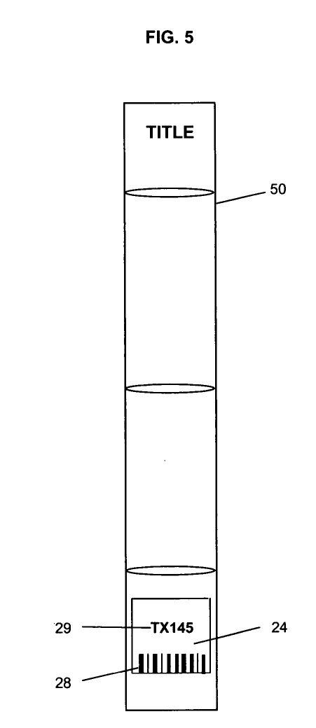

FIG. 5 provides for the continuing use of the form assembly 10 of the present invention and includes the piece 50 to be added to the collection and label 24 that has been printed with both machine readable and human readable indicia 28 and 29. The label has been attached to the spine of the book or piece 50 so that it would be easily viewable on the shelf of the repository or institution.

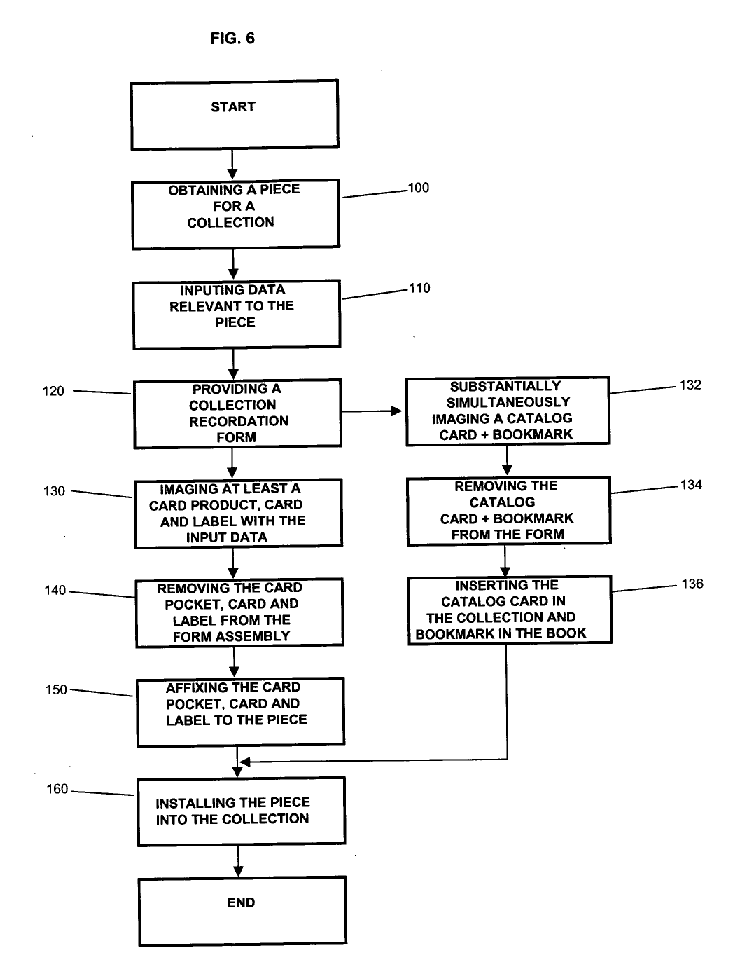

Turning now to FIG. 6, a block diagram demonstrating the use of the present invention is provided. Once the process has been started, a piece is obtained at step 100. The piece may be acquired through acquisition, donation or other suitable and known means. Next, a reference technician, librarian, resource guide, custodian or the like input data into a personal computer (PC) at step 110. The personal computer may be located at the site of the repository or may be at a location remote from the collection or repository. Next, at step 120 a collection recordation form is provided. The collection recordation form may have any number of elements, but will in this embodiment contain at least a card pocket, recordation card and at least one removable label.

The form including those elements that are separable from the form are imaged with indicia at step 130. The indicia that is provided on each of the elements has some level of commonality or matching of information. Once the form has been processed and the information recorded, the card pocket, recordation card and label are removed at step 140 and affixed to the library book as shown in FIGS. 4 and 5 as discussed herein at step 150. Finally, after each of the elements that are to be used in connection with the particular piece for the collection has been added, the piece is then installed into the collection at step 160 and the process is ended.

In an additional related embodiment, at step 132 other separable elements such as a bookmark, catalog card, and other labels are substantially simultaneously imaged with information. Again, this information may match that which has been provided at step 130 in connection with preparing the pocket card, recordation card and first removable label. However, other indicia may be provided such as marketing and advertising indicia which may be representative of a sponsor of the institution, promotional offering or the like. At step 134, the catalog card is removed and placed in the appropriate area at step 136 such as a card catalog or other filing area where a researcher may locate the information. Also at step 136 the additional label could be applied to another portion of the piece or to another area for use in identification and the bookmark distributed to a patron or inserted in the piece.

It will thus be seen according to the present invention a highly advantageous business form assembly suitable for use in maintaining a collection has been provided. While the invention has been described in connection with what is presently considered to be most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form assembly for maintaining collections, comprising;
a first substrate having first and second faces, said first face is coated with a pattern of pressure sensitive adhesive;
a second substrate substantially coextensive with said first substrate and having first and second faces, said second face is in contact with said first face of said first substrate;
a card pocket formed in said second substrate by a first die cut defining an outer perimeter of said card pocket, said card pocket having a die cut internally of said outer perimeter defining an opening in said pocket to allow receipt of a recordation card;
said recordation card formed in said second substrate by a second die cut defining an outer perimeter of said recordation card, said outer perimeter of said recordation card is less than said outer perimeter of said card pocket so that said recordation card will fit within said opening;
at least one removable label formed in said second substrate by a third die cut defining an outer perimeter of said removable label, said outer perimeter of said removable label is less than the outer perimeter of each of said card pocket and said recordation card;
at least one additional removable element formed in said second substrate by a fourth die cut defining an outer perimeter of said removable element; and
at least a portion of said card pocket and said removable label having a pressure sensitive adhesive.

2. A business form assembly as recited in claim 1, wherein said form assembly includes at least a second removable label formed in said second substrate by a die cut.

3. A business form assembly as recited in claim 1, wherein said at least one additional removable element is a book mark.

4. A business form assembly as recited in claim 1, wherein said at least one additional removable element is a catalog card.

5. A business form assembly as recited in claim 1, wherein said form assembly includes a catalog card formed by a die cut in said second substrate.

6. A business form assembly as recited in claim 1, wherein said first substrate is coated with a release coating on said first face so as to allow the pressure sensitive adhesive to be removed along with said label and said card pocket.

7. A business form assembly as recited in claim 1, wherein said card pocket is provided with a U shaped adhesive pattern substantially adjacent a portion of the perimeter of a bottom portion of said card pocket.

8. A business form assembly as recited in claim 1, wherein said at least one removable label is provided with machine readable indicia.

9. A business form assembly as recited in claim 1, wherein said at least one removable label is provided with alpha and numeric indicia.

10. A business form assembly as recited in claim 1, wherein said form assembly includes a radio frequency identification tag.

11. A method of using a form assembly for maintaining a collection, comprising the steps of;
obtaining a piece for installation in a collection;
inputting data relating to the piece in a computer;
providing a collection recordation form, said collection recordation form including at least a card pocket, recordation card and a removable label;
imaging at least the card pocket, recordation card and removable label;
removing the card pocket, recordation card and removable label from the recordation form;
affixing the card pocket, recordation card and label to the piece; and
installing the piece into the collection.

12. A method as recited in claim 11, wherein said recordation form further includes a catalog card and book mark.

13. A method as recited in claim 12, including a further step of substantially simultaneously imaging a catalog card and book mark after the step of imaging.

14. A method as recited in claim 13, including a further step of removing a catalog card and book mark from said form assembly after the step of substantially simultaneously imaging.

15. A method as recited in claim 14, including a further step of inserting the catalog card in a collection and bookmark into a book after the step of removing the catalog card and bookmark.

16. A method as recited in claim 14, wherein the bookmark is imaged with advertising and marketing collateral.

17. A method as recited in claim 11, wherein information provided on the recordation card, card pocket and removable label has matching elements.

18. A business form intermediate for use in recording pieces for a collection, comprising;
a laminate having at least a first and second sheet, each of said sheets having a first face and a second face, said sheets of said laminate are joined to one another through use of a pressure sensitive adhesive;
a series of die cuts provided in said first sheet of said laminate to create a number of separable elements that include at least a card pocket, recordation card, label and at least one other removable element, each of said die cuts defining an outer perimeter of each of said card pocket, recordation card, label and removable element;
said card pocket having a cut creating an opening into which said recordation card will fit once said card and said card pocket are removed from said laminate and said card pocket having an area defined by said perimeter which is greater than an area of said recordation card defined by the perimeter of recordation card;
said label having an area defined by the perimeter of the die cut for said label with said area being less than each of said areas of said card pocket and said recordation card; and
said at least one other removable element having an area defined by the perimeter of the die cut for said at least one other removable element, and said area is at least equal to said area of said label.

19. A business form intermediate as recited in claim 18, wherein said at least one other removable element is selected from a group including a bookmark, a catalog card and pressure sensitive label.

20. A business form intermediate as recited in claim 18, wherein said pattern of adhesive includes a U shaped pattern for said card pocket.

21. A business form intermediate as recited in claim 18, wherein said intermediate is printable by a non-impact printer.

22. A business form intermediate as recited in claim 18, wherein said intermediate is substantially planar.

23. A business form intermediate as recited in claim 18, wherein said intermediate includes a radio frequency identification tag.

24. A business form intermediate as recited in claim 18, wherein each of the separable elements is provided with matching indicia.
